(19) United States
(12) Patent Application Publication
(10) Pub. No.: US 2026/0338357 A1
(43) Pub. Date: Oct. 29, 2026

(54) HEADLAMP ASSEMBLY

(71) Applicant: MILWAUKEE ELECTRIC TOOL CORPORATION, Brookfield, WI (US)

(72) Inventors: Kyle M. Lehman, Franksville, WI (US); Brian A. Foster, Milwaukee, WI (US); Matthew D. Strommen, Greendale, WI (US); Victor G. Cinq-Mars, Milwaukee, WI (US); Christina Y. Prestidge-Kadrlik, Pewaukee, WI (US); Ashton L. Krepelka, Shorewood, WI (US); Duane W. Wenzel, Mukwonago, WI (US)

(21) Appl. No.: 19/656,017

(22) Filed: Apr. 23, 2026

Related U.S. Application Data
(60) Provisional application No. 63/796,814, filed on Apr. 29, 2025.

(51) Int. Cl. F21V 21/084; F21S 9/02

(52) U.S. Cl. CPC F21V 21/084; F21S 9/02

(57) ABSTRACT

A headlamp assembly may include a strap configured to be worn by a user. A headlamp assembly may include a headlamp including a battery receptacle configured to receive a battery, and a light assembly having an output element configured to be powered by the battery and a housing that supports the output element. A headlamp assembly may include a mounting bracket coupled to the headlamp and the strap, the mounting bracket including a rigid frame and a flexible pad, the flexible pad coupled to the rigid frame and configured to engage a head or a hardhat of the user.

### CROSS-REFERENCE TO RELATED APPLICATION

This application claims priority to U.S. Provisional Application No. 63/796,814, filed Apr. 29, 2025, the entire contents of which are incorporated by reference herein.

### FIELD OF INVENTION

The present disclosure relates to lighting systems, and more particularly to headlamps and headlamp assemblies.

### BACKGROUND

Headlamps are typically configured to be attached to a user’s head or to a hardhat via an attachment mechanism. Headlamps include a light source, which may, for example, include a single LED or a plurality of LEDs. The light source is configured to illuminate an area in front of the user. Some headlamps may include a battery pack attached to the headlamp and electrically coupled to the light source to provide power to the light source.

### SUMMARY OF THE INVENTINON

The present disclosure provides, in one aspect, a headlamp assembly including a strap configured to be worn by a user; a headlamp including a battery receptacle configured to receive a battery, and a light assembly having an output element configured to be powered by the battery and a housing that supports the output element; and a mounting bracket coupled to the headlamp and the strap, the mounting bracket including a rigid frame and a flexible pad, the flexible pad coupled to the rigid frame and configured to engage a head or a hardhat of the user.

The present disclosure provides, in another aspect, a headlamp including a battery receptacle configured to receive a battery; a light assembly mounted to the battery receptacle at an interface, the light assembly including an output element configured to be powered by the battery and a housing that supports the output element; and a seal positioned between the battery receptacle and the housing of the light assembly at the interface, the seal forming a light pipe for at least a portion of a user interface.

The present disclosure provides, in another aspect, a headlamp assembly including a strap configured to be worn by a user; a headlamp including a battery receptacle configured to receive a battery, and a light assembly having an output element configured to be powered by the battery and a housing that supports the output element; and a mounting bracket coupled to the headlamp and the strap, the mounting bracket including a frame including a first edge and a second edge opposite the first edge, a first arm extending from adjacent the first edge of the frame towards the second edge of the frame, the first arm including a first cantilevered finger that engages the headlamp to control rotation of the headlamp relative to the mounting bracket, and a second arm extending from adjacent the second edge of the frame towards the first edge of the frame, the second arm including a second cantilevered finger that engages the headlamp to control rotation of the headlamp relative to the mounting bracket.

Other aspects of the invention will become apparent by consideration of the following detailed description and accompanying drawings.

### BRIEF DESCRIPTION OF THE DRAWINGS

FIG. 1A is a front, top perspective view of a headlamp assembly according to one embodiment of the present disclosure, the headlamp assembly including a headlamp and a mounting bracket.

FIG. 1B is a front, bottom perspective view of the headlamp assembly of FIG. 1A.

FIG. 2 is a perspective view of the headlamp assembly of FIG. 1A coupled to a hard hat by a strap of the headlamp assembly.

FIG. 3A is a top view of the headlamp assembly of FIG. 1A.

FIG. 3B is a bottom view of the headlamp assembly of FIG. 1A.

FIG. 4A is a perspective view of a battery receptacle of the headlamp of FIG. 1A.

FIG. 4B is an enlarged perspective view of a portion of the headlamp with a light assembly removed illustrating a light pipe.

FIG. 4C is an enlarged cross-sectional view of a portion the headlamp of FIG. 1A, taken along section line 5-5 of FIG. 1A.

FIG. 5 is cross-sectional view of the headlamp assembly of FIG. 1A, taken along section line 5-5 in FIG. 1A.

FIG. 6 is an end view of the headlamp assembly of FIG. 1A, illustrating an end cap.

FIG. 7 is a perspective view of a light assembly of the headlamp of FIG. 1A.

FIG. 8 is a rear view of the mounting bracket of the headlamp assembly of FIG. 1A.

FIG. 9 is a front perspective view of the mounting bracket of FIG. 8.

FIG. 10 is a rear perspective view of the mounting bracket of FIG. 8.

FIG. 11 is an enlarged cross-sectional view of the mounting bracket of FIG. 8 taken from a first end of the headlamp, illustrating the mounting bracket engaged with the track of the headlamp of FIG. 1A and being rotated in a first rotational direction.

FIG. 12 is an another enlarged cross-sectional view of the mounting bracket of FIG. 8 taken from a second end of the headlamp, illustrating the mounting bracket engaged with the track of the headlamp of FIG. 1A and being rotated in the first rotational direction.

FIG. 13 is a rear view of the mounting bracket of FIG. 8 illustrating a flexible pad.

FIG. 14 is a top view of the headlamp assembly of FIG. 1A engaged with a user’s head or hardhat.

FIG. 15 is a side view of the headlamp assembly of FIG. 1A engaged with a user’s head or hardhat.

FIG. 16 is yet another top view of the headlamp assembly of FIG. 1A engaged with a user’s head or hardhat illustrating a flexible pad according to another embodiment.

FIG. 17 is yet another top view of the headlamp assembly of FIG. 1A engaged with a user’s head or hardhat illustrating the flexible pad of FIG. 16.

FIG. 18 is a rear perspective view of another mounting bracket for use with the headlamp of FIG. 1A.

FIG. 19 is an enlarged cross-sectional view of the mounting bracket of FIG. 18, illustrating the mounting bracket engaged with the track of the headlamp of FIG. 1A and being rotated in a rotational direction.

FIG. 20 is a rear view of another mounting bracket for use with the headlamp of FIG. 1A.

FIG. 21 is a rear perspective view of the mounting bracket of FIG. 20.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

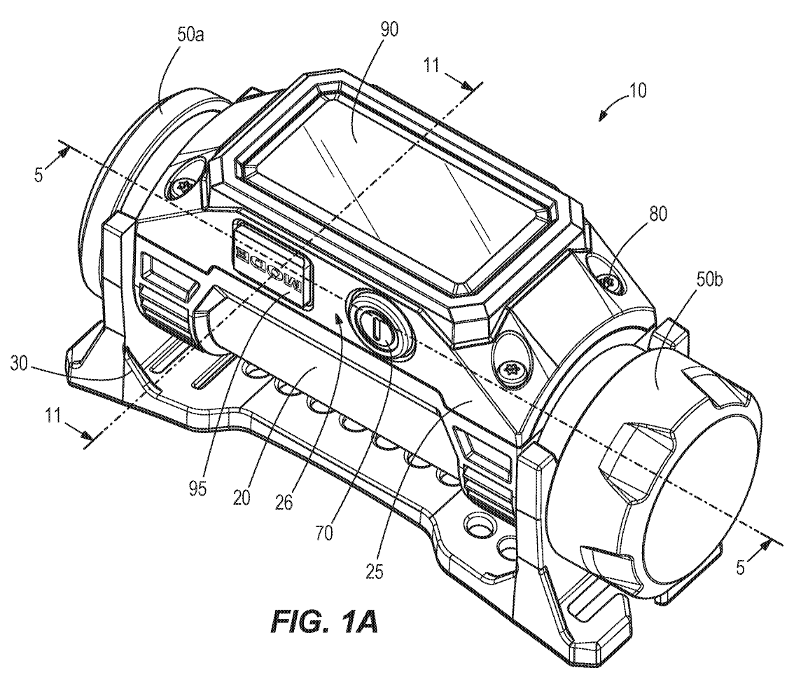

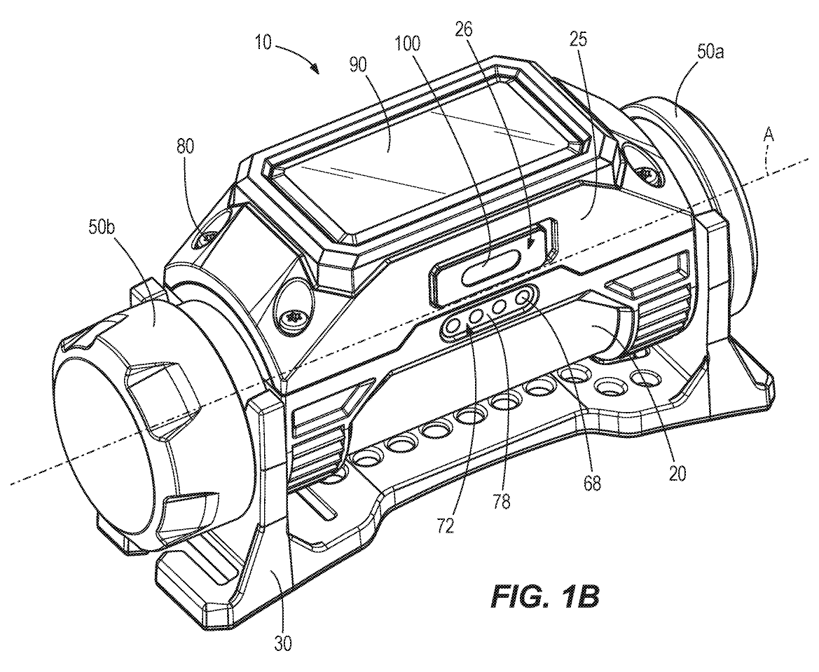

FIGS. 1A-3B illustrate a headlamp assembly 10. The headlamp assembly 10 selectively illuminates an area, such as a workspace. The illustrated headlamp assembly 10 includes a strap 15 that conforms to a user’s head, a hardhat, or other similar surface. The headlamp assembly 10 also includes a headlamp 20 and a mounting bracket 30 coupled to the headlamp 20. The mounting bracket 30 receives the strap 15 to secure the headlamp 20 to the user’s head or hardhat.

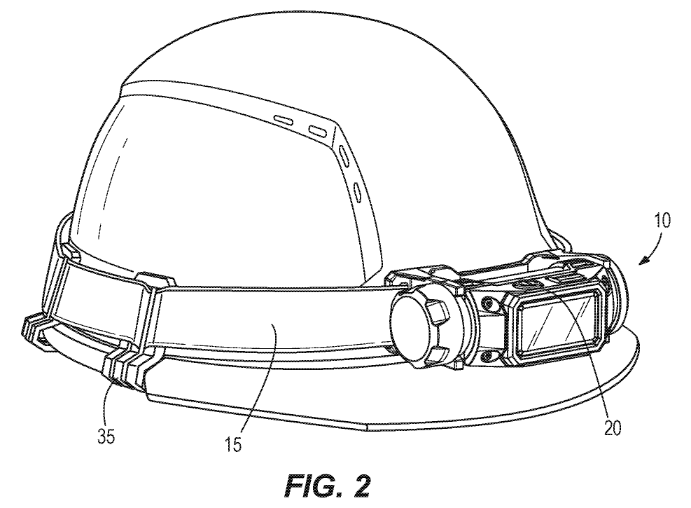

In the illustrated embodiment, the strap 15 is composed of an elastic material that can be stretched to surround a user’s head or a hard hat. In some embodiments, the strap 15 may be a semi-rigid flexible material. Referring to FIG. 2, the strap 15 is secured in place on a hard hat by a plurality of mounting clips 35 that are spaced evenly around a rear brim of the hard hat. In some scenarios, the strap 15 may be worn directly on a user’s head without the hard hat or the mounting clips 35.

As shown in FIGS. 1A and 1B, the headlamp 20 includes a battery receptacle 21, a light assembly 25, and a user interface 26. In the illustrated embodiment, the light assembly 25 and the user interface 26 are formed separately from the battery receptacle 21. In other embodiments, the battery receptacle 21 and the light assembly 25 are formed as a singular piece. The user interface 26 is positioned on the light assembly 25. In the illustrated embodiment, the headlamp 20 is positioned toward a front side of the hard hat or user’s head. In other embodiments, the headlamp 20 may be positioned elsewhere. In some embodiments, the headlamp assembly 10 may include a second strap coupled to the headlamp 20 and that engages an upper surface of a user’s head or the hard hat for improved stability of the headlamp assembly 10.

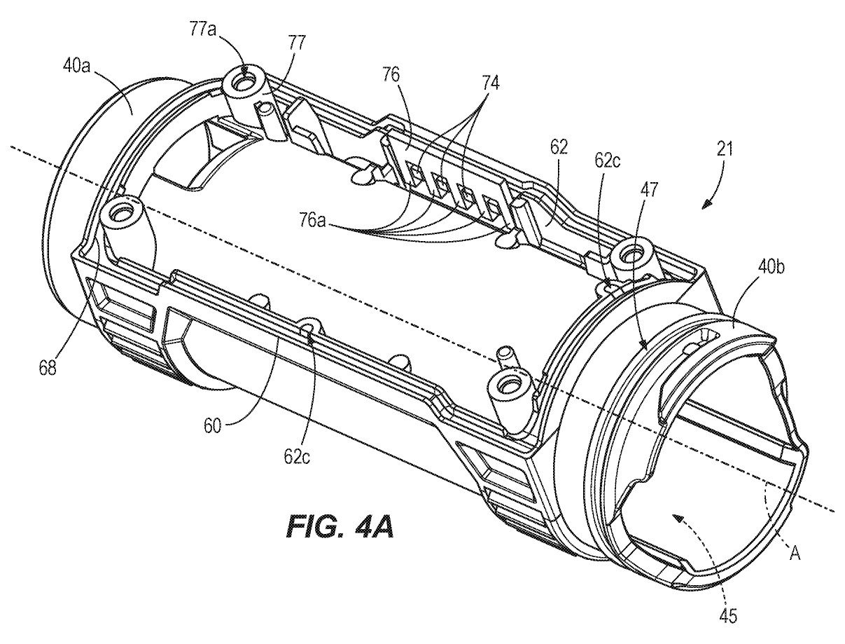

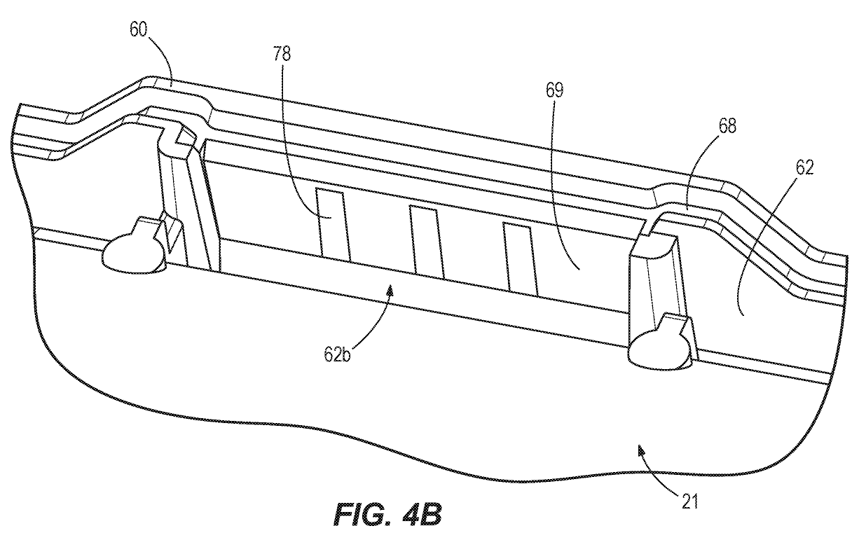

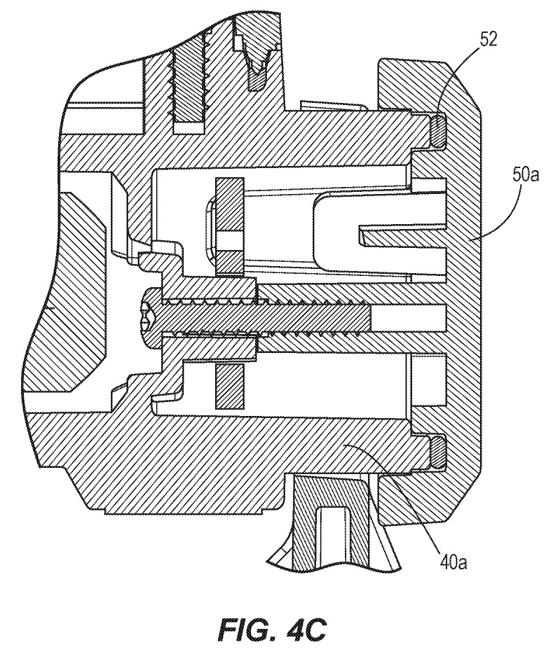

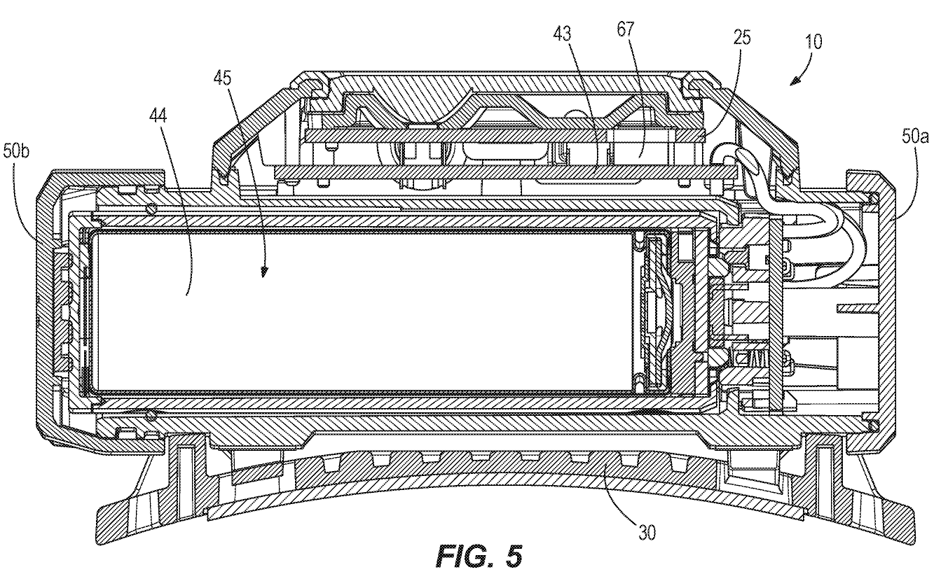

Referring to FIGS. 4A and 5, the battery receptacle 21 forms a body of the headlamp 20. The battery receptacle 21 extends from a first end 40a to a second end 40b along a central axis A. The central axis A is also a longitudinal axis of the headlamp 20. In the illustrated embodiment, the battery receptacle 21 is a substantially cylindrical shell. The battery receptacle 21 has a cylindrical cross-section that corresponds with the cylindrical cross-section of a battery 44 such as a rechargeable lithium-ion battery pack. The battery 44 is insertable into the battery receptacle 21 along the central axis A. In particular, the battery receptacle 21 includes a compartment 45 that receives the battery 44. In other embodiments, the battery receptacle 21 may instead receive disposable alkaline batteries (e.g., AA batteries or the like). In other embodiments, the battery receptacle 21 may have a prismatic cross-section or another shape to accommodate other battery types.

Referring to FIGS. 1A, 1B, 3A, 3B, 4A, and 4C, the battery receptacle 21 receives a pair of end caps 50a, 50b. The end caps 50a, 50b are secured to the ends 40a, 40b of the battery receptacle 21 to secure the battery 44 within the battery receptacle 21. An annular face seal 52 is positioned between the first end cap 50a and the first end 40a. The face seal 52 may be, for example, an O-ring, an X-ring, or other suitable annular member.

The face seal 52 applies a compressive force against the first end cap 50a that biases the first end cap 50a away from the first end 40a. In some embodiments, the first end cap 50a may be fixedly secured to the first end 40a and thus not designed to be removable from the battery receptacle 21. Once secured to the first end 40a, the first end cap 50a shields the battery receptacle 21 and the battery 44 from external elements that could cause structural or electrical damage such as water. In other embodiments, the first end cap 50a may be fixedly sealed to the first end 40a by a fastener, a radial seal, or by another similar component or method of manufacture to shield the battery 44 and the compartment 45 from externally caused damage.

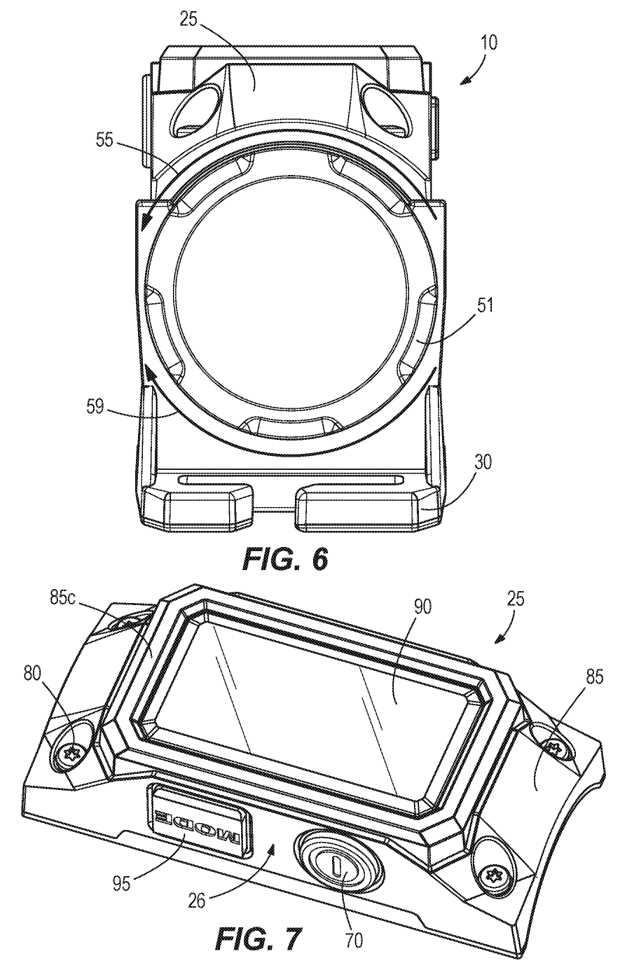

Referring to FIGS. 4A and 6, the second end cap 50b and the second end 40b include cooperating geometric features 47 (FIG. 4A). The cooperating geometric features 47 permit the second end cap 50b to be removably coupled to the second end 40b. For example, the second end cap 50bmay be rotatably fastened to the second end 40bin a first direction 55, as shown in FIG. 6, to secure the second end cap 50b in place. Conversely, the second end cap 50b may be rotated in a second direction 59 opposite the first direction 55 to remove the second end cap 50b from the battery receptacle 21. If the second end cap 50bis removed from the battery receptacle 21, the battery 44 may be removed and replaced. In the illustrated embodiment, the second end cap 50b includes a plurality of notches 51 formed into the second end cap 50b to aid a user in rotating the second end cap 50b in either the first direction 55 or the second direction 59. In some embodiments, the cooperating geometric features 47 may include threaded ends or twist lock geometries.

Referring to FIGS. 4A, 4B, and 5, the battery receptacle 21 further includes an outer casing 60 and an inner casing 62. The outer casing 60 and the inner casing 62 extend from the battery receptacle 21. In the illustrated embodiment, the outer casing 60 and the inner casing 62 extend longitudinally along the central axis A. A perimeter of the inner casing 62 is smaller than a perimeter of the outer casing 60. As shown by FIG. 4A, the perimeter of the inner casing 62 is positioned inside of the perimeter of the outer casing 60. The outer casing 60 and the inner casing 62 are formed complementarily to one another such that the perimeters of the casings 60, 62 have the same shape. For example, in the illustrated embodiment, the perimeter of the outer casing 60 has a generally rectangular shape. Consequently, the perimeter of the inner casing 62 also has a generally rectangular shape to complement the shape of the perimeter. In other embodiments, the perimeters of the casings 60, 62 are squared shaped. The inner casing 62 further includes an opening 62bformed therein.

Referring to FIGS. 4A and 4B, a seal 68 is positioned between the outer casing 60 and the inner casing 62. The seal 68 includes a light pipe 69 (FIG. 4B). In the illustrated embodiment, the light pipe 69 is integrally formed with a remainder of the seal 68. In other embodiments, the seal 68 and the light pipe 69 are formed as a singular piece. The seal 68 is partially received within a plurality of anchor points 62c formed in the inner casing 62. The anchor points 62chelp secure the seal 68 in place relative to the outer casing 60 and the inner casing 62. In the illustrated embodiment, the light pipe 69 is aligned with a portion of the user interface 26. For example, the light pipe 69 may be aligned with a fuel gauge 72 (FIG. 1B) of the user interface 26 to direct light from indicator lights within the battery receptacle 21 to outside of the battery receptacle 21, as explained below. In some embodiments, the seal 68 is formed of a transparent material. In other embodiments, the seal 68 may be formed of an elastomeric polymer material such as rubber.

The battery receptacle 21 further includes a plurality of posts 77 that extend from the battery receptacle 21. In the illustrated embodiment, the battery receptacle 21 includes four posts 77 that are positioned at the corners of the inner casing 62. In other embodiments, the battery receptacle 21 may include fewer or more posts 77 and/or the posts 77 may be located elsewhere on the battery receptacle 21. The posts 77 help couple the light assembly 25 to the battery receptacle 21. The seal 68 defines a perimeter of the interface (that is, the posts 77 and other structures that receive the light assembly 25) that the light assembly 25 is mounted to.

Referring also to FIGS. 4A, 4C, and 7, the fuel gauge 72 is positioned within the opening 62b of the inner casing 62. The fuel gauge 72 includes a plurality of indicator lights 74. In the illustrated embodiment, the indicator lights 74 are positioned adjacent the light pipe 69 and inside of a perimeter defined by the seal 68. The fuel gauge 72 further includes a divider 76 positioned within the opening 62b. The divider 76 includes a plurality of legs 76a. Each indicator light 74 is positioned between a pair of legs 76a such that the indicator lights 74 are separated from one another. The indicator lights 74 may be arranged differently in other embodiments. In some embodiments, each indicator light 74 is associated with a corresponding component of the user interface 26 and performs a specific function. For example, an indicator light 74 may be associated with a power actuator, a mode selector, or another user input to indicate battery charge level, operating mode, charging status, or another operating condition of the headlamp assembly 10.

The fuel gauge 72 is operable to indicate an amount of charge remaining in the battery 44 housed in the battery receptacle 21. In the illustrated embodiment, the fuel gauge 72 includes four indicator lights 74 (e.g., LEDs) that generally correspond to the amount of charge remaining in the battery 44. For example, illuminating all four indicators lights 74 signifies that the battery 44 is fully or near-fully charged, while illuminating only one indicator light 74 signifies the battery 44 is low on charge (e.g., less than 25%). In other embodiments, the fuel gauge 72 may include fewer or more indicator lights 74. The fuel gauge 72 may automatically turn on when the headlamp 20 is turned on by actuating the power actuator 70, and then may automatically turn off after a short period of time (e.g., 5 seconds). In other embodiments, the fuel gauge 72 may remain on as long as the headlamp 20 remains on.

FIG. 7 illustrates the light assembly 25 of the headlamp assembly 10. The light assembly 25 receives power from the battery 44. In the illustrated embodiment, the light assembly 25 includes a circuit board 43 (FIG. 5), one or more LEDs 67 (FIG. 5) supported by the circuit board 43, and a housing 85. The circuit board 43 and the LEDs 67 are positioned within the housing 85. In the illustrated embodiment, the light assembly 25 includes two LEDs 67. For example, the light assembly 25 may include a spot LED and a flood LED. In other embodiments, the light assembly 25 may include fewer or more LEDs 67. Additionally, the light assembly 25 may include other types of LEDs 67. The housing 85 includes a top face 85a, a bottom face 85b, and a side face 85c. In the illustrated embodiment, the housing 85 is mounted to the battery receptacle 21 by four fasteners 80 (e.g., screws or the like) that are inserted into blind bores 77a of the posts 77. In other embodiments, the housing 85 and the battery receptacle 21 may be coupled together by snap geometries, magnetic fasteners, rivets, and the like. When mounted to the battery receptacle 21, the housing 85 engages the seal 68, enclosing the internal electronic components between the housing 85 and the battery receptacle 21.

The light assembly 25 further includes a lens 90. The lens 90 is received by the side face 85cof the housing 85 to cover and protect the LEDs 67. The lens 90 functions as a luminary conduit such that the light emitted from the LEDs 67 may be directed by the lens 90 to illuminate a workspace. In the illustrated embodiment, the lens 90 is transparent. In other embodiments, the lens 90 may be a different color, such as blue, green, yellow, and any other desired color along the light spectrum. The LEDs 67 are configured to operate in a plurality of lighting modes, as will be described in more detail below. In some embodiments, LEDs 67 themselves may be configured to emit colored light (e.g., LEDs 67 may be configured to emit red light, blue light, green light, and any other desired color along the light spectrum, when excited by electrical current). The LEDs 67 may optionally be configured to emit yellow or white light, in some cases, if a colored lens is present.

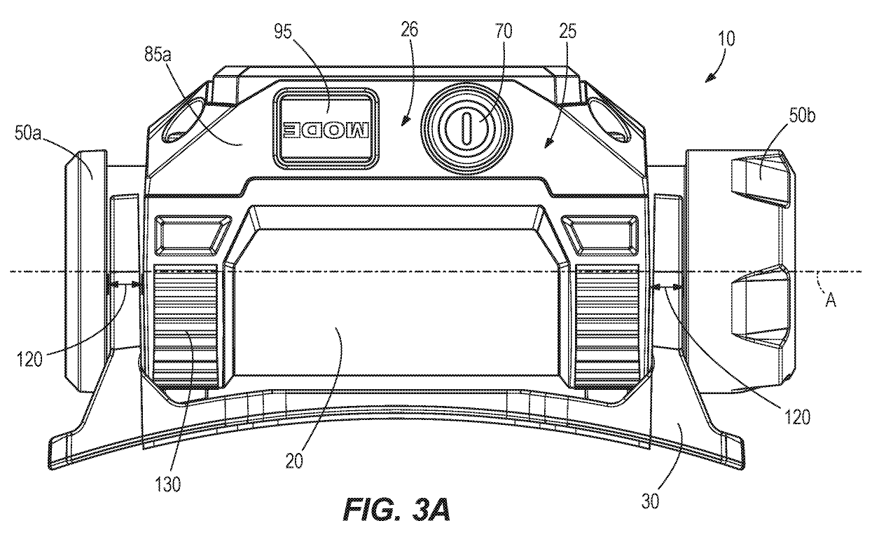

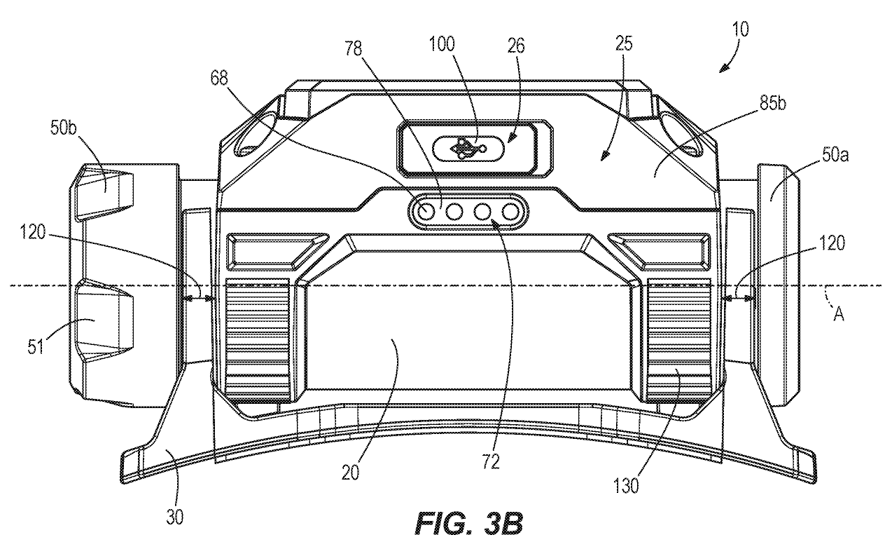

FIGS. 3A and 3B illustrate the user interface 26. The illustrated user interface 26 is positioned on the top face 85a and the bottom face 85b of the housing 85. The user interface 26 is configured to control operation of the headlamp 20. In the illustrated embodiment, the user interface 26 includes a power actuator 70, a mode selector 95, a charging port 100, and the light pipe 69. In other embodiments, the user interface 26 may have other configurations or include additional features and components. The power actuator 70 is operable to activate (e.g., turn on and off) the headlamp 20 and, more particularly, the LEDs 67. The mode selector 95 is operable to toggle the headlamp 20 and, more particularly, the LEDs 67 between a plurality of lighting modes. The power actuator 70 and the mode selector 95 are both positioned on the top face 85a of the housing 85. In the illustrated embodiment, the power actuator 70 and the mode selector 95 are push buttons. In other embodiments, the power actuator 70 and the mode selector 95 may include other suitable actuators, such as rotatable dials, slider switches, and the like.

Referring to FIGS. 3A and 7, the power actuator 70 may be actuated (e.g., depressed) to activate an ON mode in which light is emitted from the LED and an OFF mode in which the LEDs 67 do not emit light. The operational modes of the headlamp 20 include the plurality of lighting modes of the LEDs 67. The mode selector 95, when depressed, enables a user to manipulate the intensity of the light emitted from the LEDs 67 in the ON mode. The plurality of lighting modes includes a high output luminescence ON mode (“HIGH mode”), a medium output luminescence ON mode (“MEDIUM mode”), and a low output luminescence ON mode (“LOW mode”). The plurality of lighting modes may also include a flood mode, in which only the flood LED is on, a spot mode, in which only the spot LED is on, or a full mode, in which both the flood LED and the spot LED are on. In some embodiments, the plurality of lighting modes may include a power burst mode (“BOOST mode”). In the power boost mode, some or all of the LEDs 67 may emit an amplified light output that is greater than the high output luminescence of the HIGH mode for a predetermined period of time. After the predetermined period of time ends, the LEDs 67 may revert back to the previous mode (e.g., HIGH, MEDIUM, or LOW) or to a set mode (e.g., HIGH). For example, the LEDs 67 may output 1000 lumens for a period of 60 seconds when operating in BOOST mode. In other embodiments, the LEDs 67 may output a higher or lower lumen level for a shorter of longer time duration while in BOOST. In other embodiments, the plurality of lighting modes may include a non-flashing ON mode (“STEADY mode”), a fast flashing ON mode (“FAST FLASH mode”), and a slow flashing ON mode (“SLOW FLASH mode”). In other embodiments, the headlamp assembly 10 may include fewer or more modes. Additionally, or alternatively, the headlamp assembly 10 may include different types of modes.

During operation of the headlamp assembly 10, the expectation of the user is that each mode emits a brightness/light type suitable for a desired application or scenario. The multiple modes of the headlamp assembly 10 allow the user to advantageously switch between outputs without requiring the user to switch headlamps. Stated another way, the headlamp assembly 10 is configured to accomplish the functions of a variety of headlamps such that the user can rely on a single headlamp rather than needing multiple headlamps depending on the desired application (e.g., a first headlamp with high lumen output for area lighting, a second headlamp with medium lumen output for recreation, a separate flashing safety light, etc.).

As shown in FIGS. 1B and 3B, the port 100 is positioned on the bottom face 85b of the housing 85. In the illustrated embodiment, the port 100 is a USB-type port. The port 100 allows the battery 44 in the battery receptacle 21 to be charged by an external device. In some embodiments, the port 100 may be a bi-directional port that also allows an external device (e.g., cellular device, power tool, etc.) to receive power from the battery 44 housed in the battery receptacle 21. In other embodiments, the user interface 26 may include multiple ports 100. For example, the user interface 26 may include a first port for charging the battery 44 and a second port for receiving power from the battery 44. In other embodiments, the port 100 may be a different type of port, may be located elsewhere on the housing 85, or may be omitted. The fuel gauge 72 is positioned on the battery receptacle 21 of the headlamp 20 adjacent the port 100. In other embodiments, the fuel gauge 72 may be located elsewhere on the battery receptacle 21

Referring back to FIG. 4B, the light pipe 69 directs illumination from the indicator lights 74 (FIG. 4A) inside the battery receptacle 21 to the exterior surface of the battery receptacle 21. As noted above, the fuel gauge 72 is aligned with the light pipe 69 (FIG. 4A). The illustrated light pipe 69 is at least partially divided by a plurality of ribs 78 to reduce light bleed between the indicator lights 74. In the illustrated embodiment, the light pipe 69 is divided into four segments by three ribs 78. In other embodiments, the light pipe 69 may be divided into fewer or more segments, depending on the number of indicators. In some embodiments, the light pipe 69 may also or alternatively be aligned with a different component of the user interface 26. For example, the light pipe 69 may be aligned with the power actuator 70, the mode selector 95, and/or the charging port 100. In such embodiments, the light pipe 69 may form a ring or other pattern around the power actuator 70, the mode selector 95, and/or the charging port 100 to illuminate perimeters of the power actuator 70, the mode selector 95, and/or the charging port 100.

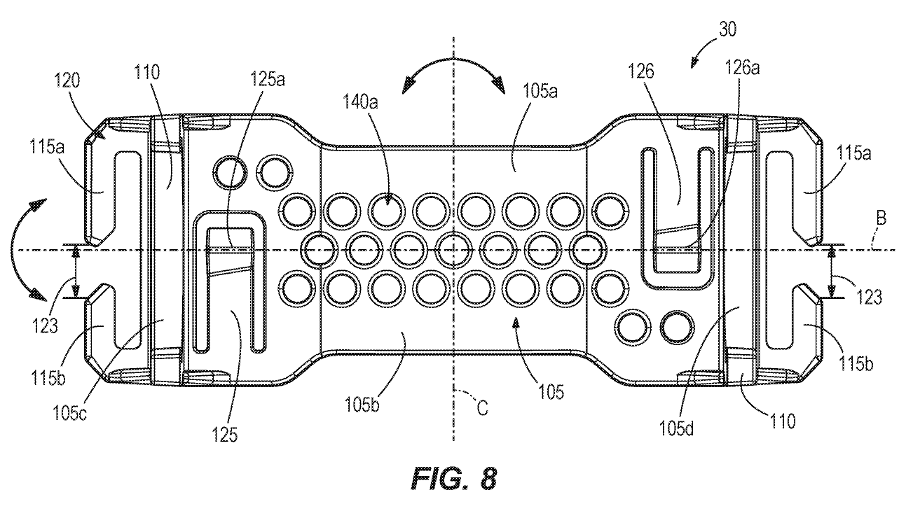

FIGS. 8-10 illustrate the mounting bracket 30. The mounting bracket 30 includes a rigid frame 105, prongs 110, and jaws 115. In the illustrated embodiment, the rigid frame 105 is generally rectangular in shape. In other embodiments, the rigid frame 105 may have other shapes. The rigid frame 105 includes a first edge 105a, a second edge 105b, a third edge 105c, and a fourth edge 105d. The second edge 105b is opposite the first edge 105a. The third edge 105c extends between the first and second edges 105a, 105b. The fourth edge 105d is opposite the third edge 105c and also extends between the first and second edges 105a, 105b. Collectively, the edges 105a–105d define a perimeter of the rigid frame 105.

In the illustrated embodiment, the rigid frame 105 includes a plate‑like region formed within the perimeter defined by the first, second, third, and fourth edges 105a–105d. The plate‑like region has a generally I‑shaped profile, including opposed longitudinal rail portions extending along the rigid frame 105 and a central web portion extending between the rail portions. The central web portion connects the opposed rail portions such that the plate‑like region provides structural continuity across the rigid frame 105 while permitting controlled flexibility. The central web portion defines a recessed portion 106 of the rigid frame 105. The recessed portion 106 is configured to receive a flexible pad 140, as described below. In the illustrated embodiment, the recessed portion 106 is formed within the central web portion of the I‑shaped plate‑like region, such that portions of the rail portions remain structurally continuous on opposite sides of the recessed portion.

The prongs 110 extend outwardly from the rigid frame 105. One of the prongs 110 (e.g., a first prong) is adjacent the third edge 105c of the rigid frame 105. Another of the prongs 110 (e.g., a second prong 110) is adjacent the fourth edge 105d of the rigid frame 105. The prongs 110 extend in a direction perpendicular to a bracket midline axis B of the rigid frame 105. The bracket midline axis B is a longitudinal axis extending through a center of the rigid frame 105. The prongs 110 are adapted to engage the headlamp 20, and more particularly, the battery receptacle 21 as shown in FIGS. 3A and 3B. In particular, the contour of each prong 110 is formed complementarily to the shape of the battery receptacle 21 such that the prongs 110 may clamp to the battery receptacle 21. Once the prongs 110 are clamped to the battery receptacle 21, the headlamp 20 is rotatably coupled to the mounting bracket 30. To couple the mounting bracket 30 to the battery receptacle 21, the prongs 110 are aligned with gaps 120 (FIGS. 3A and 3B) that lie between the end caps 50a, 50b and the housing 85. The headlamp 20 is removable from the mounting bracket 30, enabling a user to operate the headlamp 20 independently from the mounting bracket 30 and the strap 15.

The mounting bracket 30 includes a retention fixture configured to secure the strap 15 to the headlamp assembly 10. In the illustrated example, the retention fixture is the jaws 115. One of the jaws 115 (e.g., a first jaw) extends outwardly from the third edge 105c of the rigid frame 105. Another of the jaws 115 (e.g., a second jaw) extends outwardly from the fourth edge 105d of the rigid frame 105. The jaws 115 extend in a direction parallel to the bracket midline axis B and perpendicular to the prongs 110. The jaws 115 receive ends of the strap 15 to secure the strap 15 to the mounting bracket 30. Each jaw 115 includes a first jaw half 115a and a second jaw half 115b. Each respective jaw 115 defines an opening 123 that may receive one end of the strap 15. In other embodiments, the retention fixture is a female end of a buckle configured to receive a male end of a buckle formed on the end of the strap.

With continued reference to FIGS. 8-10, the mounting bracket 30 further includes a first arm 125 and a second arm 126. The mounting bracket 30 may include a fewer or greater number of arms in other embodiments. The first arm 125 extends from adjacent the first edge 105a of the rigid frame 105 toward the second edge 105b of the rigid frame 105. The second arm 126 extends from adjacent the second edge 105b of the rigid frame 105 toward the first edge 105a of the rigid frame 105. In other words, the arms 125, 126 extend from opposite edges of the rigid frame 105 toward each other. The illustrated arms 125, 126 extend sufficient distances such that the arms 125, 126 overlap in a lateral direction parallel to the bracket midline axis B. For example, each arm 125 extends more than half a distance from its respective edge 105a, 105b toward the other edge 105a, 105b. In the illustrated embodiment, the bracket midline axis B intersects both arms 125, 126. The arms 125, 126 are spaced apart laterally along the bracket midline axis B. In addition, the arms 125, 126 are located between the prongs 110. In other embodiments, the arms 125, 126 may be located laterally outside of the prongs 110 (e.g., the prongs 110 may be located between the arms 125, 126. Each arm 125, 126 is cantilevered. Each arm 125, 126 also includes a cantilevered finger 125a, 126a at a distal or free end of the corresponding arm 125, 126. The cantilevered fingers 125a, 126a are laterally aligned with each other and intersected by the bracket midline axis B. The cantilevered fingers 125a, 126aare engageable with corresponding tracks 130 (FIGS. 3A and 3B) formed on the battery receptacle 21 of the headlamp assembly 10. In the illustrated embodiment, a first track 130 is formed adjacent the first end 40a of the battery receptacle 21 and a second track 130 is formed adjacent the second end 40b of the battery receptacle 21.

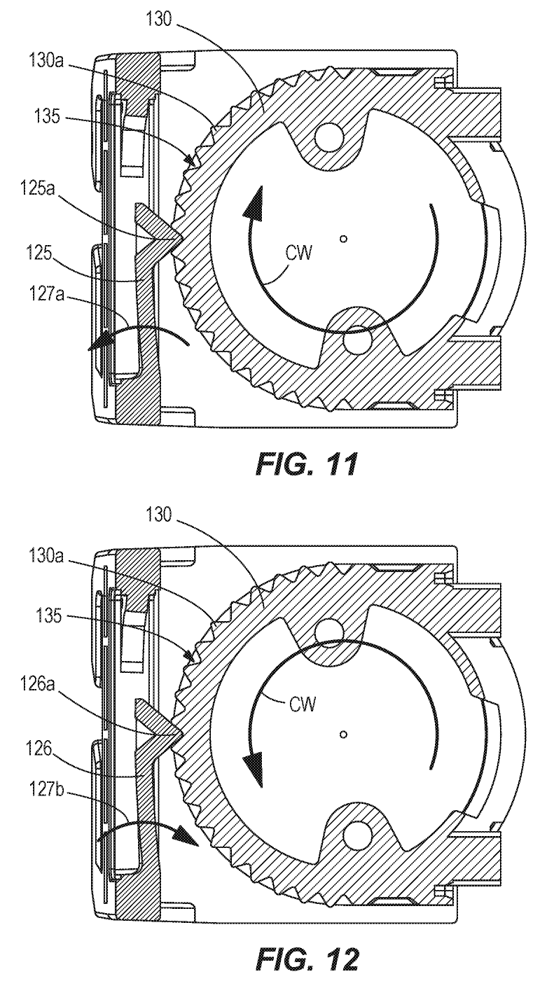

Referring to FIGS. 11 and 12, each track 130 includes a plurality of teeth 130a. The teeth 130a are arranged circumferentially about the track 130. A plurality of channels 135 are formed between adjacent teeth 130a. The cantilevered fingers 125a, 126a are selectively received in the channels 135 to temporarily hold or secure the headlamp 20 in a fixed rotational position relative to the mounting bracket 30. As such, the cantilevered fingers 125a, 126a can control (e.g., limit or restrict) rotation of the headlamp 20 relative to the mounting bracket 30 by releasably holding the headlamp 20 in various rotational positions. The plurality of teeth 130a of each track 130 are arranged uniformly on each track 130. The uniform arrangement of the teeth 130a on each track 130 allows the cantilevered fingers 125a, 126a of each arm 125, 126 to engage the same, corresponding channels 135 of each track 130. Each arm 125, 126 is sufficiently pliant to permit slight adjustments of the arms 125, 126 such that the cantilevered fingers 125a, 126a may seamlessly engage the plurality of teeth 130a without damaging the structural integrity of the arms 125, 126.

Referring back to FIGS. 8-10, the arms 125, 126 cooperate with the tracks 130 to enable the headlamp 20 to be fixed relative to the mounting bracket 30 in a plurality of rotational positions. The pliancy of the arms 125, 126 enables the headlamp 20 to be rotated about the central axis A relative to the mounting bracket 30. Each channel 135 corresponds to an angle at which the headlamp 20 may be positioned relative to the mounting bracket 30 along an angular range of 180 degrees. In the illustrated embodiment, the cantilevered fingers 125a, 126a are simultaneously received in corresponding channels 135 of the track 130 to inhibit rotation of the headlamp 20 relative to the mounting bracket 30. The headlamp 20 may be adjusted at regular angular intervals of 2 degrees, 5 degrees, 10 degrees, or any other desired angular interval along the angular range by rotating the headlamp 20 until the cantilevered fingers 125a, 126a engage a selected channel 135. In some embodiments, the plurality of teeth 130a are spaced about the track 130 at irregular intervals such that the channels 135 may be positioned more densely in regions that correspond with more desirable fixed angular positions of the headlamp 20. A moment 127a, 127b is induced on each arm 125, 126 as the headlamp 20 is rotated about the central axis A.

The first moment 127a is induced on the first arm 125 when the headlamp 20 is rotated in a first direction. The second moment 127b is induced on the first arm 125 when the headlamp 20 is rotated in a second direction. Because the second arm 126 is oriented opposite the first arm 125, moments induced on the second arm 126 when the headlamp 20 is rotated are opposite the moments 127a, 127b induced on the first arm 125. As such, the same amount of force is required to rotate the headlamp 20 in either rotational direction. In other words, rotation of the headlamp 20 relative to the mounting bracket 30 is directionally balanced when the arms 125, 126 are arranged on opposite edges of the rigid frame 105. In some embodiments, the mounting bracket 30 may include additional offset arms to provide additional support to the battery receptacle 21 as the headlamp 20 rotates about the rotational axis A.

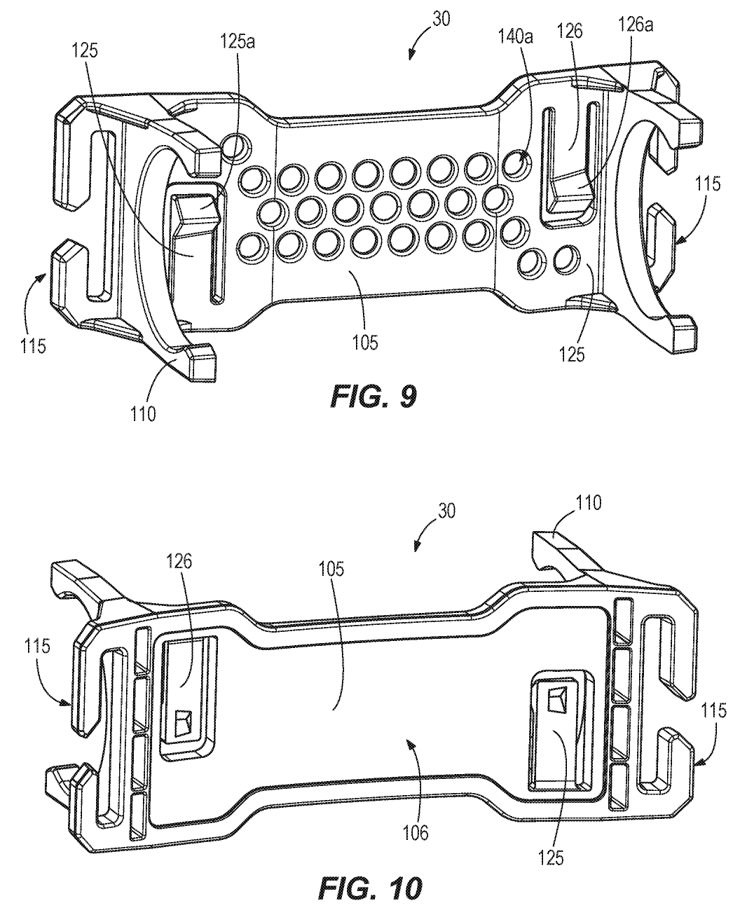

Referring to FIGS. 8 and 9, the rigid frame 105 further defines a plurality of perforations 140a formed in the plate‑like region. In the illustrated embodiment, the perforations 140a are formed in the central web portion of the plate‑like region adjacent the recessed portion that receives the flexible pad 140. The perforations 140a substantially fill a majority of the central web portion. The perforations 140a are formed on a side of the rigid frame 105 opposite from the support pad 140. In the illustrated embodiment, the perforations 140a are formed on a first side of the rigid frame 105 that faces the headlamp 20, and the support pad 140 is positioned on a second side of the rigid frame 105 that faces a user. The perforations 140a are uniformly sized. In the illustrated embodiment, the perforations 140a are circular. In other embodiments, the perforations 140a may have other shapes and/or may not be uniformly sized or shaped. The illustrated perforations 140a are arranged in a series of rows extending generally parallel to the midline axis B of the mounting bracket 30. In the illustrated embodiment, the perforations 140a are arranged in three main rows, with a few perforations 140a outside of the rows (e.g., in fourth and fifth rows) to fill the plate-like region. In other embodiments, the perforations 140a may be arranged in fewer or more rows or may be arranged in a non-organized pattern. In the illustrated embodiment, adjacent rows of perforations 140a are offset relative to one another. The perforations 140a extend only partially through the rigid frame 105 such that the perforations 140a are visible from one side of the rigid frame 105 while an opposite side of the rigid frame 105 includes a continuous solid wall that maintains structural integrity of the rail portions.

The perforations 140a reduce bending stiffness of the central web portion of the I‑shaped plate‑like region while the rail portions remain substantially unperforated, such that the rigid frame 105 exhibits directional flexibility across the plate‑like region. In some embodiments, the perforations 140a may extend entirely through the rigid frame 105. In such embodiments, when the headlamp assembly 10 is secured to a user’s head or hardhat, air may flow through the perforations 140a in the rigid frame 105, enhancing heat transfer at the interface between the user’s head and the mounting bracket 30 and reducing heat buildup and perspiration.

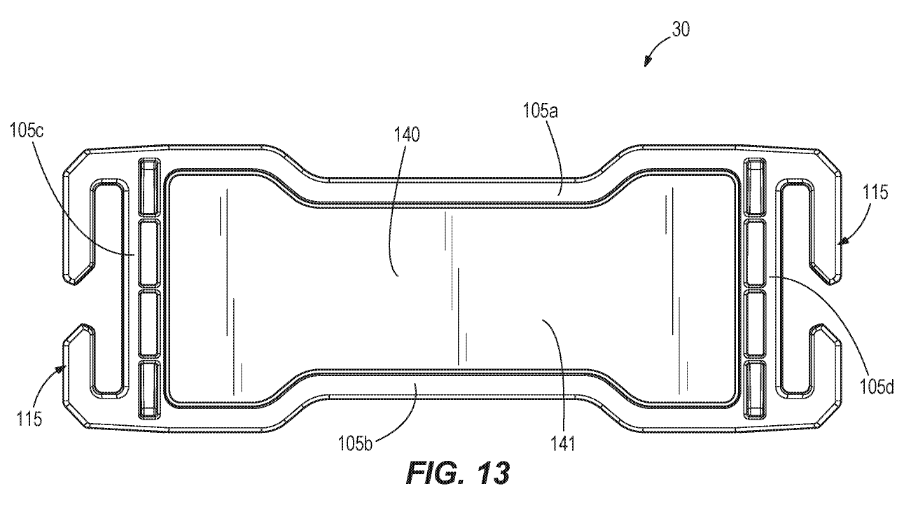

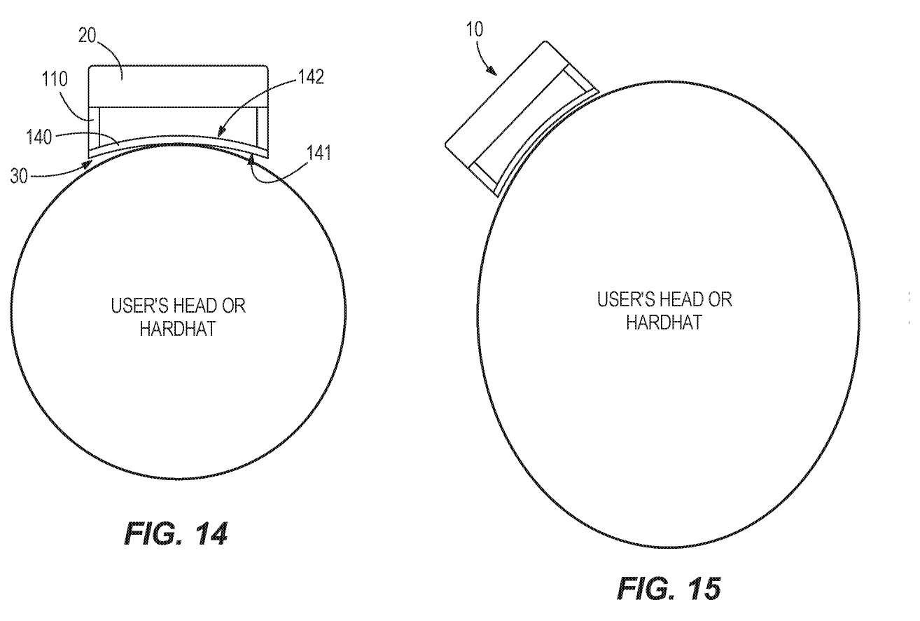

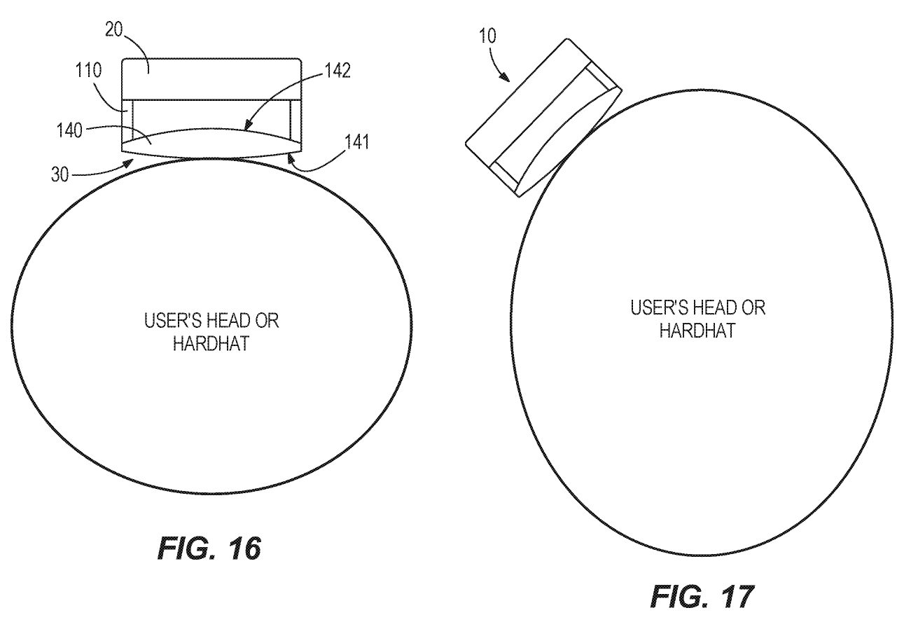

Referring to FIG. 13, the mounting bracket 30 further includes the flexible pad 140 coupled to the rigid frame 105.The flexible pad 140 is positioned within the recess portion 106 and overlays at least a portion of the plate‑like region, such that the flexible pad 140 covers the central web portion while the rail portions bound and support the flexible pad 140. The flexible pad 140 is formed of an elastomeric polymer material such as rubber. The flexible pad 140 includes a first face 141 configured to engage the user’s head or hardhat and a second face 142 (FIGS. 14 and 16) facing the rigid frame 105. The second face 142 engages the rigid frame 105 in the recessed portion 106. In the illustrated embodiment, the flexible pad 140 is shaped to complement the recessed portion and the underlying I‑shaped plate‑like region of the rigid frame 105. The flexible pad 140 may be secured to the rigid frame 105 by over‑molding, adhesive, fasteners, or combinations thereof, such that the mounting bracket 30 forms a singular structure. The flexible pad 140 may be curved (e.g., concave) about the midline axis B (FIG. 8) of the bracket 30. The flexible pad 140 may also be curved (e.g., concave) about a second axis C (FIG. 8) of the bracket 30 that is perpendicular to the midline axis B.

Alternatively, the flexible pad 140 may be curved away from the headlamp 20 and toward the user’s head or hardhat. In other words, the flexible pad 140 may be convex relative to the headlamp 20. The flexible pad 140 may be curved (e.g., convex) about the midline B (FIG. 8) of the bracket 30. The flexible pad 140 may also be curved (e.g., convex) about the second axis C (FIG. 8) of the bracket 30. In such an embodiment, the flexible pad 140 may bow out from the rigid frame 105. When loaded against the user’s head or hardhat, the flexible pad 140 may flex like a leaf spring.

When a load is applied by the user’s head or hardhat, the flexible pad 140 and the rigid frame 105 bend in unison. Thus, the mounting bracket 30 may bend to generally match the curvature of the user’s head or hardhat. Bending of the mounting bracket 30 is accommodated primarily by flexure of the central web portion of the I‑shaped plate‑like region, while the rail portions provide structural support and distribute load across the rigid frame 105. In some embodiments, the flexible pad 140 may be concave or convex relative to the headlamp 20 to conform to different head geometries. In some embodiments, perforations 140a may additionally extend through the flexible pad 140. The mounting bracket 30 is configured to conform to a curvature of the user’s head or hardhat. In the illustrated embodiment, the mounting bracket 30 is curved to generally match the curvature of the user’s head or hardhat. For example, as shown in FIGS. 14 and 15, the mounting bracket 30 is curved toward the headlamp 20 and away from the user’s head or hardhat. In other words, the mounting bracket 30 is concave relative to the headlamp 20. The mounting bracket 30 may be curved (e.g., concave) about the midline axis B (FIG. 8). The mounting bracket 30 may also be curved (e.g., concave) about a second axis C (FIG. 8) that is perpendicular to the midline axis B.

Alternatively, as shown in FIGS. 16 and 17, the mounting bracket 30 may be curved away from the headlamp 20 and toward the user’s head or hardhat. In other words, the mounting bracket 30 may be convex relative to the headlamp 20. The mounting bracket 30 may be curved (e.g., convex) about the midline B (FIG. 8). The mounting bracket 30 may also be curved (e.g., convex) about the second axis C (FIG. 8). When loaded against the user’s head or hardhat, the mounting bracket 30 may flex like a leaf spring.

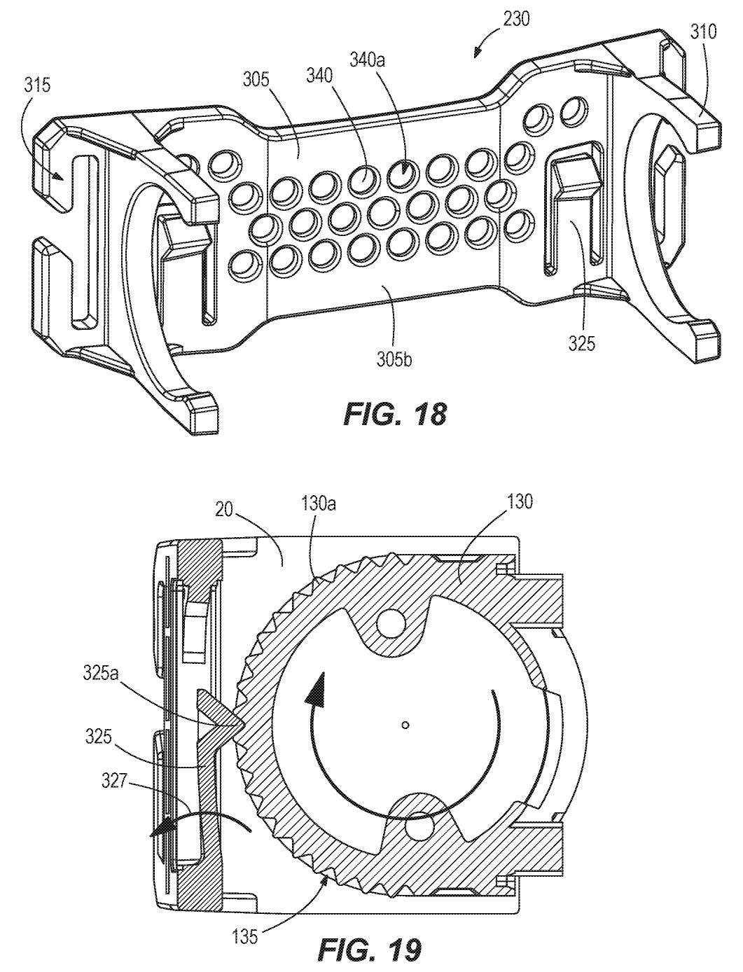

FIGS. 18 and 19 illustrate another mounting bracket 230 for use with the headlamp 20. The mounting bracket 230 is similar to the mounting bracket 30 described above, with like features represented by like reference numbers plus “200.” The mounting bracket 230 includes a rigid frame 305 configured to couple the headlamp 20 to the strap 15. The mounting bracket 230 includes a rigid frame 305, prongs 310, and jaws 315. The prongs 310 extend from the rigid frame 305 and are shaped complementarily to the battery receptacle 21 such that the prongs 310 clamp to the battery receptacle 21 and permit the headlamp 20 to rotate about the central axis A. The mounting bracket 230 also includes a pad 340. The mounting bracket 230 also includes a plurality of perforations 340a. In this embodiment, the perforations 340a extend entirely through the frame 305. The perforations 340a may allow airflow through the mounting bracket 230.

In this embodiment, the mounting bracket 230 further includes a pair of arms 325 extending from the same edge of the rigid frame 305 of the mounting bracket 230. In particular, the arms 325 both extend from the same edge 305b of the rigid frame 305. Each arm 325 is cantilevered and includes a cantilevered finger 325a at a distal end thereof. The cantilevered fingers 325a are engageable with the tracks 130 formed on the battery receptacle 21 of the headlamp 20. The cantilevered fingers 325a are selectively received within the channels 135 to rotationally secure the headlamp 20 relative to the mounting bracket 230.

During rotation of the headlamp 20 relative to the mounting bracket 230, rotation in a first direction imparts a reaction force on the cantilevered fingers 325a that induces a moment 327 causing the arms 325 to flex outwardly. Rotation of the headlamp 20 in a second, opposite direction imparts a reaction force that biases the cantilevered fingers 325a into the channels 135. As a result, a greater amount of force is required to rotate the headlamp 20 in the second direction than in the first direction. Accordingly, the mounting bracket 230 of this embodiment exhibits direction‑dependent resistance to rotation of the headlamp 20.

As the headlamp 20 is rotated in a counterclockwise direction relative to the mounting bracket 230, the rotation of the headlamp 20 imparts a reaction force upon the cantilevered fingers 325a that induces a moment 327 on the arms 325. The induced moment 327 compels the cantilevered fingers 325a to move outwardly from the channel 135. When the headlamp 20 is rotated in a clockwise direction, the reaction force imparted upon the cantilevered fingers 325a compels the cantilevered fingers 325a to remain in the channel 135. To overcome the tendency of the cantilevered fingers 325a to remain in the channel 135, a greater amount of force is applied by the user in the clockwise direction to rotate the headlamp 20 when compared to rotating the headlamp 20 in the counterclockwise direction. Since the arms 325 are oriented in the same direction, the amount of force required to rotate the headlamp 20 in the clockwise direction is amplified. In contrast to the mounting bracket 30, in which the arms are positioned on opposite sides of the rigid frame 105 to provide directionally balanced rotational resistance, rotation of the headlamp 20 relative to the mounting bracket 230 requires different amounts of user-applied force depending on the direction of rotation.

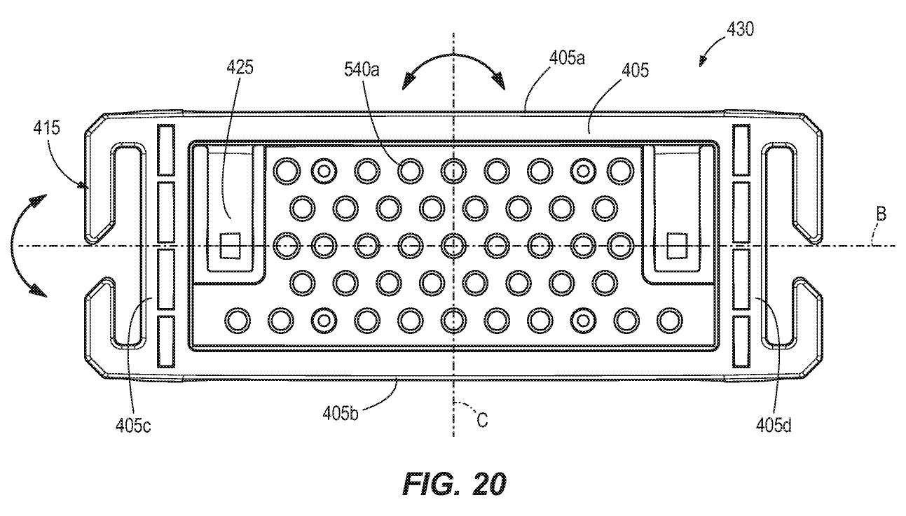

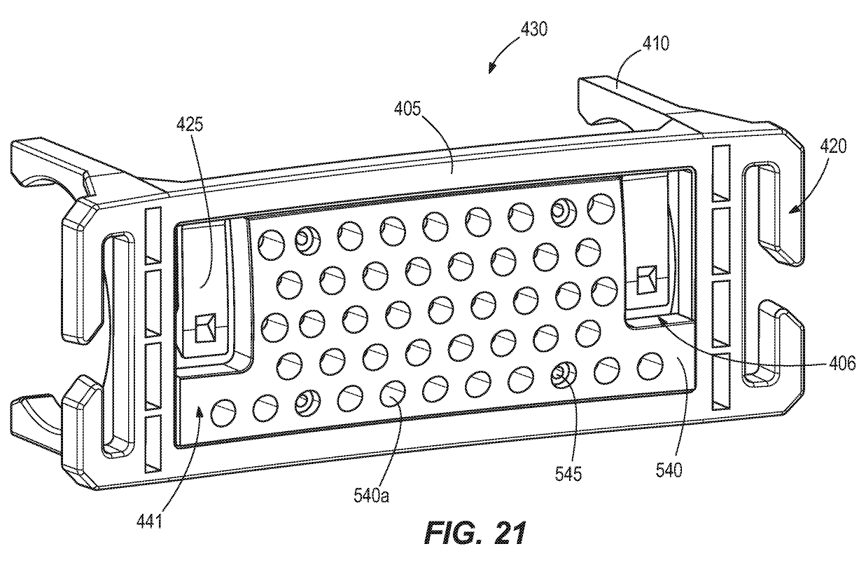

FIGS. 20 and 21 illustrate another mounting bracket 430 for use with the headlamp 20. The mounting bracket 430 is similar to the mounting bracket 30 described above, with like features represented by like reference numbers plus “400.” The mounting bracket 430 includes a rigid frame 405 configured to couple the headlamp 20 to the strap 15. The rigid frame 405 includes a first edge 405a, a second edge 405b, a third edge 405c, and a fourth edge 405d defining a perimeter of the rigid frame 405. Similar to the mounting bracket 30, the mounting bracket 430 includes prongs 410, jaws 415, and cantilevered arms 425. The prongs 410 extend from the rigid frame 405 and are shaped complementarily to the battery receptacle 21 such that the prongs 410 clamp to the battery receptacle 21 and permit the headlamp 20 to rotate about the central axis A.

The mounting bracket 430 further includes a flexible pad 540 coupled to the rigid frame 405. In the illustrated embodiment, the flexible pad 540 is formed of an elastomeric polymer material such as rubber. The flexible pad 540 is positioned within an opening 406 of the rigid frame 405. In the illustrated embodiment, the flexible pad 540 is over-molded onto the rigid frame 405 such that the mounting bracket 430 is a singular structure. In some embodiments, the flexible pad 540 may be coupled to a plurality of projections 545 that extend from the rigid frame 405 toward the midline axis B by fasteners.

In contrast to the flexible pad 140, the flexible pad 540 defines a plurality of perforations 540a. The perforations 540a are uniformly sized. In addition, the illustrated perforations 540aare circular. In the illustrated embodiment, the perforations 540a are arranged linearly in a series of rows. The rows extend parallel to the midline axis B. The illustrated rows are offset rows such that the perforations 540a in one row are offset from the perforations 540a in adjacent rows in directions perpendicular to the midline axis B. In other embodiments, the perforations 540a may have a variety of sizes, shapes, and arrangements to provide alternative configurations. The perforations 540a enhance the flexible properties of the flexible pad 540. In addition, the perforations 540a allow the flow rate of air through the flexible pad 540. When the headlamp assembly 10 is secured to a user’s head, the perforations 540a increase the flow through the mounting bracket 430 and function as a cooling feature. The increased airflow enhances the rate of heat transfer between the region a user’s head contacts the flexible pad 540 and the ambient air such that heat is removed from the region of the head that directly contacts the flexible pad 540 and, likewise, reduces a buildup of perspiration.

Although the invention has been described in detail with reference to certain preferred embodiments, variations and modifications exist within the scope and spirit or one or more independent aspects of the invention as described.

Various features of the invention are set forth in the following claims.

What is claimed is:

1. A headlamp assembly comprising:
a strap configured to be worn by a user;
a headlamp including
a battery receptacle configured to receive a battery, and
a light assembly having an output element configured to be powered by the battery and a housing that supports the output element; and
a mounting bracket coupled to the headlamp and the strap, the mounting bracket including a rigid frame and a flexible pad, the flexible pad coupled to the rigid frame and configured to engage a head or a hardhat of the user.

2. The headlamp assembly of claim 1, wherein the flexible pad overlays at least a portion of the rigid frame.

3. The headlamp assembly of claim 2, wherein the flexible pad is positioned within a recessed portion of the rigid frame.

4. The headlamp assembly of claim 2, wherein the flexible pad is positioned within a perimeter of the rigid frame.

5. The headlamp assembly of claim 1, wherein the rigid frame includes a plurality of perforations.

6. The headlamp assembly of claim 5, wherein the plurality of perforations extend only partially through the rigid frame.

7. The headlamp assembly of claim 5, wherein the plurality of perforations are formed on a first side of the rigid frame, and wherein the flexible pad is coupled to a second side of the rigid frame opposite the first side.

8. The headlamp assembly of claim 1, wherein the mounting bracket is curved toward the headlamp.

9. The headlamp assembly of claim 1, wherein the mounting bracket includes a prong that engages the headlamp to removably couple the headlamp to the mounting bracket.

10. A headlamp comprising:
a battery receptacle configured to receive a battery;
a light assembly mounted to the battery receptacle at an interface, the light assembly including an output element configured to be powered by the battery and a housing that supports the output element; and
a seal positioned between the battery receptacle and the housing of the light assembly at the interface, the seal forming a light pipe for at least a portion of a user interface.

11. The headlamp of claim 10, wherein the seal is formed of a transparent material.

12. The headlamp of claim 10, wherein the seal defines a perimeter of the interface to which the light assembly is mounted.

13. The headlamp of claim 10, wherein the light pipe directs light from an indicator light within the headlamp to an exterior surface of the headlamp.

14. The headlamp of claim 13, wherein the indicator light is one of a plurality of indicator lights within the headlamp, wherein the light pipe directs light from each of the plurality of indicator lights to the exterior surface of the headlamp, and further comprising a divider positioned between each of the plurality of indicator lights to separate the plurality of indicator lights from one another.

15. A headlamp assembly comprising:
a strap configured to be worn by a user;
a headlamp including
a battery receptacle configured to receive a battery, and
a light assembly having an output element configured to be powered by the battery and a housing that supports the output element; and
a mounting bracket coupled to the headlamp and the strap, the mounting bracket including
a frame including a first edge and a second edge opposite the first edge,
a first arm extending from adjacent the first edge of the frame towards the second edge of the frame, the first arm including a first cantilevered finger that engages the headlamp to control rotation of the headlamp relative to the mounting bracket, and
a second arm extending from adjacent the second edge of the frame towards the first edge of the frame, the second arm including a second cantilevered finger that engages the headlamp to control rotation of the headlamp relative to the mounting bracket.

16. The headlamp assembly of claim 15, wherein the headlamp also includes a first track and a second track spaced apart from the first track, wherein the first cantilevered finger cooperates with the first track and the second cantilevered finger cooperates with the second track to control rotation of the headlamp relative to the mounting bracket.

17. The headlamp assembly of claim 16, wherein each of the first track and the second track includes a plurality of channels that defines a plurality of rotational positions for the headlamp relative to the mounting bracket.

18. The headlamp assembly of claim 15, wherein the mounting bracket also includes a first prong extending outwardly from the frame and a second prong extending outwardly from the frame to couple the mounting bracket to the headlamp.

19. The headlamp assembly of claim 18, wherein the first and second arms are positioned between the first and second prongs.

20. The headlamp assembly of claim 15, wherein the frame further includes a third edge extending between the first and second edges and a fourth edge opposite the third edge and extending between the first and second edges, wherein the mounting bracket also includes a first jaw adjacent the third edge and a second jaw adjacent the fourth edge, and wherein the first and second jaws are configured to receive the strap to secure the mounting bracket to the strap.
